(19) United States
(12) Patent Application Publication
(10) Pub. No.: US 2017/0063837 A1
(43) Pub. Date: Mar. 2, 2017

(54) PASSWORD CHECKING METHOD BASED ON RANDOM SEQUENCE

(71) Applicant: Sung-Soo PYO, Daegu (KR)

(72) Inventor: Sung-Soo PYO, Daegu (KR)

(21) Appl. No.: 15/352,876

(22) Filed: Nov. 16, 2016

Related U.S. Application Data
(63) Continuation of application No. PCT/KR2015/004828, filed on May 14, 2015.

(30) Foreign Application Priority Data
May 19, 2014 (KR) 10-2014-0059450

(51) Int. Cl. H04L 29/06; H04W 12/06

(52) U.S. Cl. CPC H04L 63/083; H04W 12/06; G06Q 20/1085

(57) ABSTRACT

The present disclosure pertains to a method for setting a password by associating an order of magnitude of a sequence provided by a device or an internet site desired to be accessed with a digit input by the user, and by making input values different according to a digit of the set order of magnitude to generate a password and make an access, when a fair user attempts the access and the device or internet site provides a random sequence. When the sequence provided by the device or the internet site is different, it is highly possible that the input values are different. Therefore, since a value input at a specific instance is not used again, even if the value is seen by a third party, the third party is not allowed to access the password.

### CROSS-REFERENCE TO RELATED APPLICATION

This application is a continuation of International Application No. PCT/KR/2015/004828, filed May 14, 2015, which claims the benefit of Korean Patent Application No. 10-2014-0059450 filed on May 19, 2014, the contents of which are incorporated by reference in their entirety.

### BACKGROUND

The present disclosure relates to a password checking method based on a random sequence. According to the method of the present disclosure, since a user is able to maximize security of a password to input the safe password, there is no concern about exposure of the password, when the password is input in an open place.

Typically, most security-required devices require passwords and such a password is a part of means for preventing a malicious third party from accessing user's information.

In particular, recently, since a mobile communication terminal contains an individual's privacy and financial information such as an electronic organizer, internet access, and payment besides a call function, when a password is exposed, the individual may suffer severe invasion of privacy and a financial loss. Therefore, security of password may not be emphasized enough.

Nevertheless, since an automatic teller machine and a mobile communication terminal are installed in a place crowded with people, it is highly possible that the password is exposed to a third party with a high-tech camera.

There are prior arts related to a method of preventing a password from being leaked, but the existing inventions depend on vision. Therefore, a user is difficult to use such an invention (a user should remember 10 randomly set keypads). There is also an invention using a visible effect (e.g. a watermark) or the like, but a user is not easy to use such an invention.

### CITATIONS

### Patent Literatures

### (Patent Literature 001) Korean Patent Application Laid-Open No. 10-2005-0002001

### (Patent Literature 002) Korean Patent Application Laid-Open No. 10-2003-0059397

### [Non-Patent Literature]

(Non-patent Literature 001) [Academic publication] Password input system for snooping prevention using Sudoku puzzle, 2011 (Electronic/information communication engineering|Donghwa Kim, et. al|Korea information science society)

### SUMMARY

The present disclosure provides a password checking method based on a random sequence which is capable of inputting a safe password of which security is maximized and confirming the same by generating the password set by establishing a correlation of digits on keypads pressed by a user with a random sequence displayed on a screen, when the user inputs the password to his/her own mobile communication terminal or an automatic teller machine in an open place.

In accordance with an exemplary embodiment of the present disclosure, a password checking method includes: setting, by a user, in advance a setting number and a password; displaying, to the user, a digit array based on a random sequence; receiving, from the user, a number on a basis of digits arrayed based on the displayed sequence; and checking whether the received number matches the password preset by the user.

The digit array based on the random sequence may be changeable on a basis of a new random sequence when the user inputs a rearrangement command.

The checking of the whether the received number matches the password preset by the user may be performed with a function preset based on the random sequence, the user's input number and password.

In accordance with another exemplary embodiment of the present disclosure, a password checking method includes: a) setting, by a user, in advance a setting number and a password; b) displaying, to the user, a digit array based on a random sequence; c) receiving, from the user, a number on the basis of digits arrayed based on the displayed sequence; and d) checking whether the received number matches the password preset by the user, wherein b) to d) are repeated twice or more.

The digit array based on the random sequence may be changeable on a basis of a new random sequence when the user inputs a rearrangement command.

The checking of the whether the received number matches the password preset by the user may be performed with a function preset based on the random sequence, the user's input number and password.

In accordance with another exemplary embodiment of the present disclosure, a non-transitory computer readable medium stores a program code causing a computer to execute a password checking method based on a random sequence, the program code including: a program code for setting, by a user, in advance a setting number and a password; a program code for displaying, to the user, a digit array based on a random sequence; a program code for receiving, from the user, a number on a basis of digits arrayed based on the displayed sequence; and a program code for checking whether the received number matches the password preset by the user.

### BRIEF DESCRIPTION OF THE DRAWINGS

Exemplary embodiments can be understood in more detail from the following description taken in conjunction with the accompanying drawings, in which:

FIG. 1 is a configuration diagram of a system for realizing a password checking method based on a random sequence according to an embodiment of the present disclosure;

FIG. 2 is a flowchart of a password checking method based on a random sequence according to an embodiment of the present disclosure;

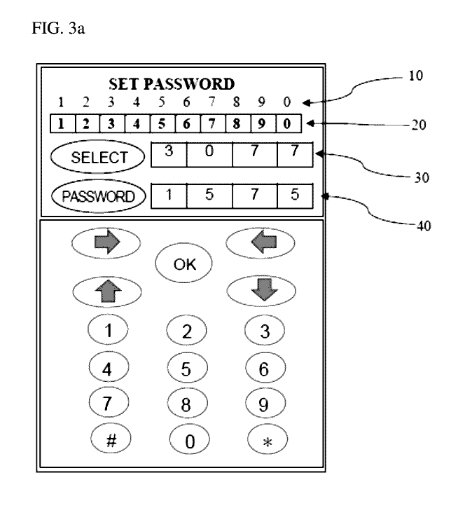

FIGS. 3A and 3B illustrate examples of a setting number and a password input widow according to an embodiment of the present disclosure.

FIG. 4 illustrates an example of a password check window according to an embodiment of the present disclosure;

FIG. 5 is a flowchart of a password checking method based on a random sequence according to an additional embodiment of the present disclosure; and

FIGS. 6 and 7 respectively illustrate examples of a password check window according to additional embodiments of the present disclosure.

### DETAILED DESCRIPTION OF EMBODIMENTS

The description below provides simplified explanation of one or more exemplary embodiments and thus provides basic understanding of the embodiments of the present disclosure. This section is not the comprehensive concept of possible embodiments, and also does not intend to distinguish a core element from all elements or to cover all possible variations, alternatives, or every aspects of the present disclosure. The sole purpose thereof is to provide one or more simplified concepts of the embodiments as introduction of the detailed description.

The present disclosure pertains to a method for setting a password by associating an order of magnitude of a sequence provided by a device or an internet site desired to be accessed with a digit input by the user, and by making input values different according to a digit of the set order of magnitude to generate a password and make an access, when a fair user attempts the access and the device or internet site provides a random sequence. When the sequence provided by the device or the internet site is different, it is highly possible that the input values are different. Therefore, since a value input at a specific instance is not used again, even if the value is seen by a third party, the third party is not allowed to access the password.

A password checking method based on a random sequence according to an embodiment of the present disclosure includes: setting in advance, by a user, a setting number and a password S210; displaying, to the user, an array of digits based on a random sequence S220; receiving, from the user, a number on the basis of the digits arrayed based on the displayed sequence S230; and checking whether the received number matches the preset password S240.

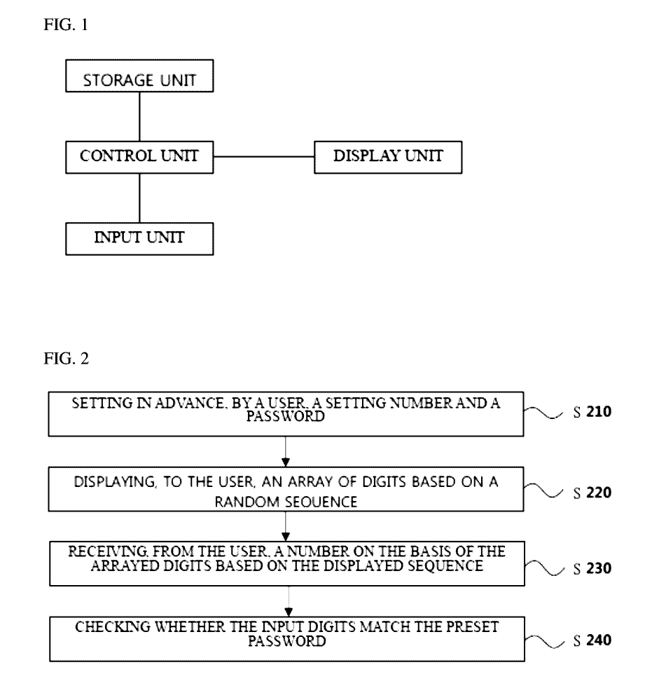

In order to execute the above-described method, a schematic system illustrated in FIG. 1 is necessary and such a system is illustrated as a configuration diagram. Hereinafter, a description about each of the above-described operations will be provided with the configuration diagram of FIG. 1

The setting of the setting number and the password S210 may be performed through a screen displayed on a display unit of the system. In this case, the input may be performed using a touch screen manner or using an input means such as a separate keyboard.

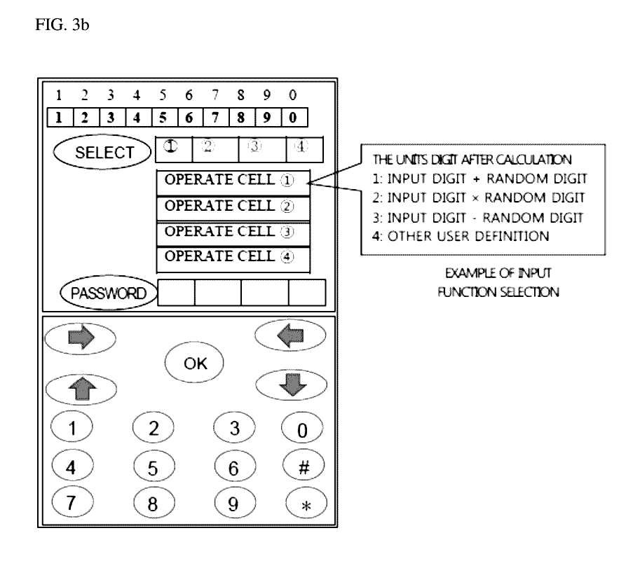

As shown in FIG. 3A, a reference numeral 10 indicates fixed places of an underlying random sequence, and these places are not changed and indicate fixed places of the created random sequence of a reference numeral 20. The reference numeral 20 indicates places at which digits 0 to 9 are represented with the random sequence. Each digit place of the random sequence may be known from the reference numeral 10.

The user inputs a selection number into a selection number input window 30 in order to set the selection number. In addition, a password is input into a password input window 40.

In the embodiment of FIG. 3A, 3077 is set as the selection number and 1575 is set as the password. These selection number and password are only known to the user.

As described above, the user sets the selection number and the password in advance and thereafter, when the user attempts an access to a system having the password input system according to an embodiment of the present disclosure, an array of digits based on the random sequence is displayed to the user (operation S210).

In this case, when setting the selection number and the password, the user may also set in advance a function to be described later. Referring to FIG. 3B, the user may set a function in advance and in this case, it is possible to define a function for all passwords or to set a different function for each password place. In addition, the user may directly set the function if necessary. In this way, since the user sets a function in advance, security of the password becomes higher.

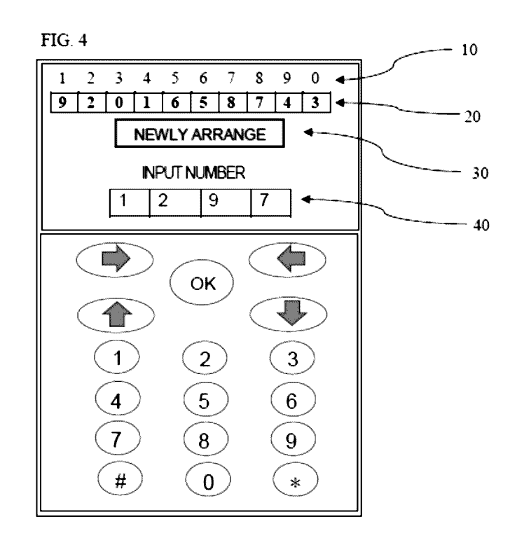

In operation S220, like the screen of an embodiment of FIG. 4, a window 40 may pop up which allows the user to input the password, and in this case, an array 20 of digits based on the random sequence is displayed underneath the fixed number 10.

In this case, when the array of digits based on the random sequence is weak in security or the user determines so, the user may receive a digit array based on a new random sequence by inputting 30 a rearrangement command.

In this way, when the digit array based on the random sequence, the user may input a password in operation S230.

In this case, the password corresponds to a number calculated with a preset function and input by the user. The function is preset based on the random sequence, the user's input number and password. In other words, a relation of f(random sequence, input number)=password is established. A function f is preset such that a password is output from the function according to the relation of the selection number preset by the user and an input number. In the embodiment of FIG. 4, the function is set such that a digit of ones place of (selection number)+(input number) become (password). Such a function is a settable part in various ways and the user knows such a function relation in advance.

In the embodiment of FIG. 4, since the function is set such that the digit of ones place of (selection number)+(input number) becomes (password), the user may see the array 20 of digits displayed by the random sequence to know that “0388”, which are digits in the random sequence, is selected in correspondence to “3077”, which is his/her selection number. In addition, in order to create “1575”, which is a password preset through the foregoing function relation, the user inputs an input number “1297” into the input window 40.

Thereafter, the system checks whether the number input through the preset function matches the preset password (operation S240). As described above, such a check may be performed with the preset function based on the random sequence, the user's input number and password.

In the above example, when the input number input by the user is “1297”, the system checks whether the password “1575” is output according to the function relation, whether the password matches the input number, and that the password does not match, when a different number is input.

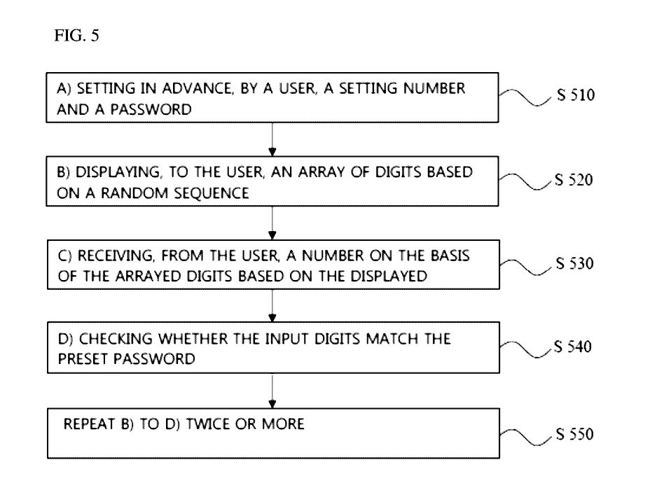

A password checking method based on a random sequence according to an additional embodiment of the present disclosure is illustrated in FIG. 5, and this method includes: a) presetting, by a user, a setting number and a password S510; b) displaying, to a user, a digit array based on a random sequence S520; c) receiving, from the user, a number on the basis of digits arrayed based on the displayed sequence S530; and d) checking whether the received number matches the preset password S540, wherein steps b) to d) are repeated twice or more S550.

Descriptions about parts identical to the above-described parts will not be provided and differences from the above-described embodiments will be mainly described herein.

In an embodiment illustrated in FIG. 5, a password will be checked twice or more. This is enabled by receiving the input number from the user twice or more on the basis of digits arrayed based on the random sequence.

For example, when it is assumed that a function identical to the function (i.e. a function through which a digit of ones place of a value obtained from (setting number+input number) becomes a password) described in relation to FIGS. 3 and 4 is used, the selection number is set as 24 and the password is set as 15 (operation S150).

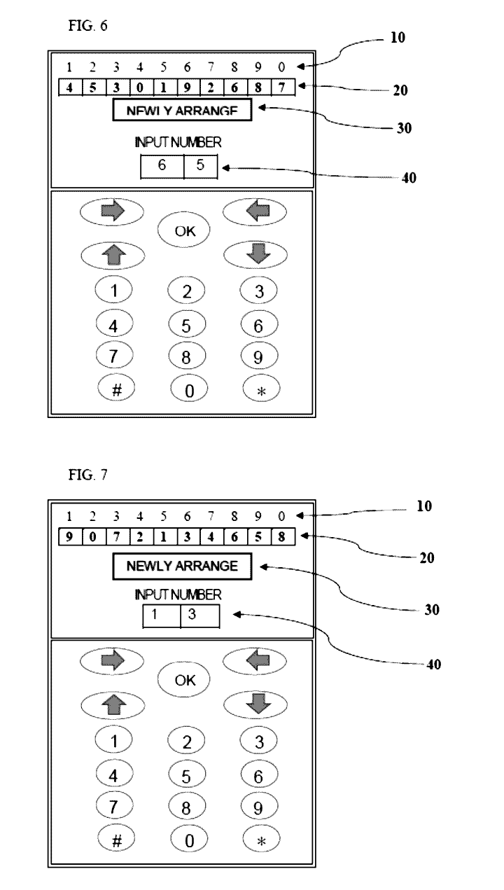

Thereafter, when the user attempts an access to the system, a digit array based on the random sequence is displayed to the user (operation S520). This is illustrated in FIG. 6, and when the digit array based on the random sequence as shown in FIG. 6 is displayed, the user inputs “65” as an input number to check the password (operations S530 and S540). Then a digit array based on the random sequence is displayed again, which is illustrated in FIG. 7. In this case, the sequence is changed and the user may check the password by inputting “13”

In this way, in a process for inputting an input number to check a password, the number of times for performing the process increases, security will rapidly increase.

On the other hand, the password checking method based on a random sequence as described above may also be embodied as a computer readable code on a non-transitory computer readable recording medium. The computer readable code includes: a computer program code for presetting, by a user, a setting number and a password; a program code for displaying, to a user, a digit array based on a random sequence; a program code for receiving, from the user, a number on the basis of digits arrayed based on the displayed sequence; and a program code for checking whether the received number matches the preset password.

The present disclosure pertains to a method for setting a password by associating an order of magnitude of a sequence provided by a device or an internet site desired to be accessed with a digit input by the user, and by making input values different according to a digit of the set order of magnitude to generate a password and make an access, when a fair user attempts the access and the device or internet site provides a random sequence. When the sequence provided by the device or the internet site is different, it is highly possible that the input values are different. Therefore, since a value input at a specific instance is not used again, even if the value is seen by a third party, the third party is not allowed to access the password.

Through the content of the present disclosure, since the user is able to maximize security of a password and input the safe password, there is no concern about exposure of the password when the password is input in an open place.

The previous description of the disclosed embodiments is provided to enable those skilled in the art to user or practice the present disclosure. Various modifications to these embodiments will be readily apparent to those skilled in the art and generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A password checking method comprising:
setting, by a user, in advance a setting number and a password;
displaying, to the user, a digit array based on a random sequence;
receiving, from the user, a number on a basis of digits arrayed based on the displayed sequence; and
checking whether the received number matches the password preset by the user.

2. The password checking method of claim 1, wherein the digit array based on the random sequence is changeable on a basis of a new random sequence when the user inputs a rearrangement command.

3. The password checking method of claim 1, wherein the checking of the whether the received number matches the password preset by the user is performed with a function preset based on the random sequence, the user's input number and password.

4. A password checking method comprising:
a) setting, by a user, in advance a setting number and a password;
b) displaying, to the user, a digit array based on a random sequence;
c) receiving, from the user, a number on the basis of digits arrayed based on the displayed sequence; and
d) checking whether the received number matches the password preset by the user, wherein b) to d) are repeated twice or more.

5. The password checking method of claim 4, wherein the digit array based on the random sequence is changeable on a basis of a new random sequence when the user inputs a rearrangement command.

6. The password checking method of claim 4, wherein the checking of the whether the received number matches the password preset by the user is performed with a function preset based on the random sequence, the user's input number and password.

7. A non-transitory computer readable medium storing a program code causing a computer to execute a password checking method based on a random sequence, the program code comprising:
a program code for setting, by a user, in advance a setting number and a password;
a program code for displaying, to the user, a digit array based on a random sequence;
a program code for receiving, from the user, a number on a basis of digits arrayed based on the displayed sequence; and
a program code for checking whether the received number matches the password preset by the user.
